(19) United States
(12) Patent Application Publication
(10) Pub. No.: US 2009/0200102 A1
(43) Pub. Date: Aug. 13, 2009

(54) Loudspeaker enclosure utilizing a rigid foam core

(76) Inventor: Eric S. Gilbert, (US)

Correspondence Address: ERIC S. GILBERT, 4151 WHITTIER STREET, SAN DIEGO, CA, 92107, US

(21) Appl. No.: 12/069,552

(22) Filed: Feb. 12, 2008

(51) Int. Cl. A47B 81/06; B32B 7/12; B32B 3/26

(52) U.S. Cl. 181/199; 428/317.1

(57) ABSTRACT

A novel construction of lightweight loudspeaker enclosure wherein the interior is substantially filled with rigid open-celled foam as a structural core. The speaker enclosure is comprised of two basic parts, the structural foam core, and a relatively thin exterior shell. The rigid foam core eliminates acoustic reflections within the interior of the enclosure and prevents flexure or vibration of the exterior shell thereby producing a loudspeaker enclosure of light weight, and high rigidity. Further this construction makes practical the manufacture of very thin or unusually shaped loudspeaker enclosures.

### CROSS-REFERENCE TO RELATED APPLICATIONS

Not applicable

### STATEMENT REGARDING FEDERALLY SPONSERED RESEARCH OR DEVELOPMENT

Not applicable

### BACKGROUND OF THE INVENTION

The primary element of any audio loudspeaker is the electro-acoustic transducer (driver) which converts an electrical signal to sound waves. In order for the driver to reproduce sounds efficiently, and accurately, an enclosure is utilized to isolate the sound waves emitted from the rear of the driver. A loudspeaker can generally be considered as a driver, enclosure, and other hardware which forms a system to convert electrical signals into sonic form.

Loudspeaker enclosures have appeared in countless variations of shape, size and features. It is widely recognized that resonances within the airspace of the enclosure and vibrations of the enclosure structure both effect the quality of the sound reproduction. It is also generally recognized that conventional loudspeaker enclosures/cabinets all share the feature of utilizing thick, rigid and relatively heavy walls in order to contain the backpressure energy with minimal enclosure vibration. A variety of bracing structures have also been proposed to further enhance the rigidity of the enclosure. The high mass of the enclosure walls minimize enclosure vibration at high frequencies, with the stiffness of the walls minimizing vibration at lower frequencies. Prior patents relate to bracing and structures to reduce standing waves, and/or enclosure vibrations (Elworthy U.S. Pat. No. 1,975,201, Weathers U.S. Pat. No. 2,866,514, Babb U.S. Pat. No. 3,953,675, Dick U.S. Pat. No. 4,690,244). There are also prior patents relating to enclosure walls made using lightweight foam boards.

Low density stuffing materials such as wool, fiberglass and foams have long been added into the interior cavity of the enclosure to absorb acoustic energy within the air space only. These materials are not intended to contribute any structural benefit to the enclosure, and minimally reduce the tendency for the enclosure walls to vibrate.

### BRIEF SUMMARY OF THE INVENTION

This patent describes for the first time a novel construction of loudspeaker enclosures that substantially reduces the weight and also very effectively prevents standing waves and enclosure vibrations by employing a fundamentally different approach. In this invention, the interior of the enclosure consists of a rigid open-celled foam core which provides the vast majority of mechanical strength. An exterior shell functions primarily to contain the driver backpressure while contributing minimally to the structural strength of the enclosure system.

The loudspeaker enclosure constructed utilizing rigid open-celled foam as a structural core has uniformly stiff walls due to the high coupling to the core. The core material therefore is highly critical in determining the stiffness and damping of the enclosure walls. The foam core also has the characteristic of acoustic damping to prevent standing waves.

### BRIEF DESCRIPTION OF THE SEVERAL VIEWS OF THE DRAWINGS

FIG. 1. Cross section view showing cut-out for driver and component identification.

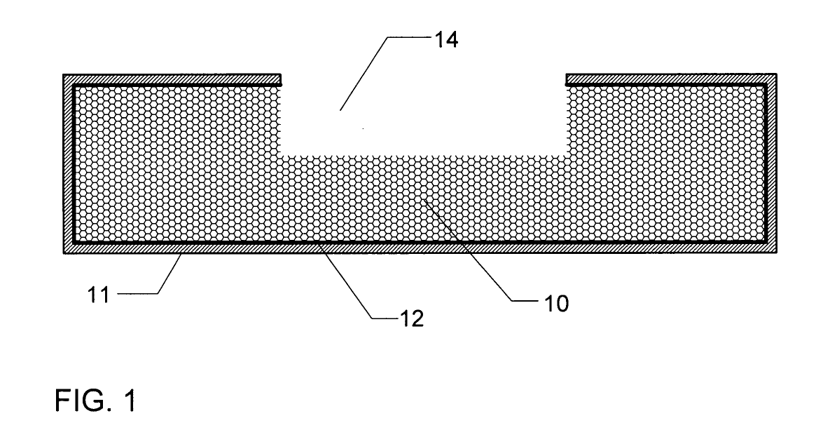

FIG. 2. Cross sectional view illustrating the variable density core.

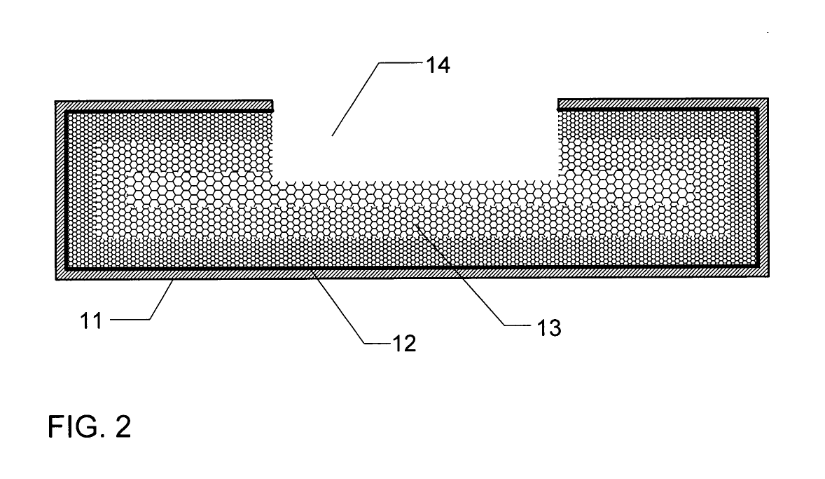

FIG. 3. Isometric view. This illustration shows the configuration of the foam core, shell, driver cavity, and an illustrative cut away of one corner.

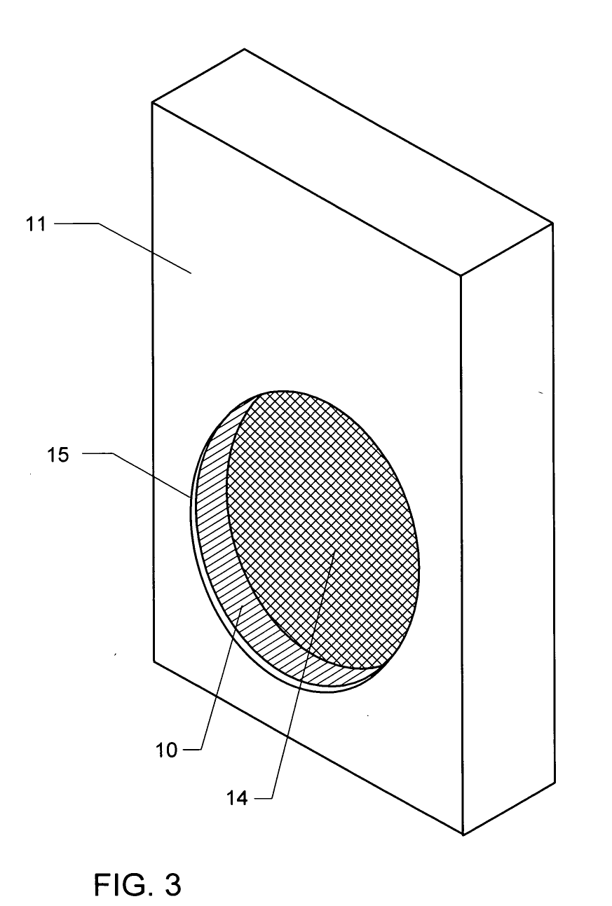

### DETAILED DESCRIPTION OF THE INVENTION

General description. In this invention, a loudspeaker enclosure has two parts; the interior of the enclosure consists of a rigid open-celled foam core which provides the vast majority of mechanical strength, and an exterior shell which functions primarily to contain the driver backpressure while contributing additional stiffness to the enclosure system.

Since resonances in the enclosure structure will negatively influence the fidelity of the loudspeaker, to eliminate those resonances is always the goal of a loudspeaker designer. The enclosure constructed utilizing rigid open-celled foam as a structural core has uniformly stiff exterior walls due to very high coupling to the core. Therefore a much thinner exterior shell may be used and the shell material is less critical compared to conventional designs. The potential benefits of this invention are several; weight reduction, cost reduction, size reduction, and greater diversity of enclosure shapes.

Core properties and important role in the system. The physical qualities of the core material therefore are highly critical in determining the stiffness and damping of the enclosure walls and are vital to the performance of this invention. The foam core also has the characteristic of acoustic damping to prevent standing waves. A specific material is not required, but appropriate core materials will posses properties of high rigidity, open-celled structure that allows movement of air, ability to be shaped, resistance to degradation. These properties generally describe certain materials classified as foams. One of the unique properties of foam type materials is that their physical properties are the same in all directions which is quite different from “bracing”. A foam core will therefore resist pressure and movement on all axis. Close mechanical coupling to the shell is necessary. Therefore the size and shape of the core exterior must substantially be the same as the shell interior.

Shell properties and important role in the system. The primary role of the shell is to contain the driver backpressure within the enclosure. Secondary roles are to provide mechanical support for mounting the driver and protecting the core from damage. Since resistance to distortion or vibration comes predominately from the core, the material and properties of the shell are less critical compared to a conventional enclosure cabinet. Plastics, metal, composite materials, or natural materials are potentially suitable. Important properties are manufacturability, resistance to damage, resistance to degradation, ability to be bonded to the core. Typical thickness of the shell would be 0.10 inch.

Variable density core. A further proposed enhancement to the foam core construction is to utilize a core with variable density such that the lowest density is near center and highest density near the shell surface. The advantages of a variable density core are expected to be improved mechanical integrity of the shell-core system, and improved acoustic damping qualities.

1. The construction of a lightweight loudspeaker enclosure comprising;
a. A rigid core which substantially fills the interior of the loudspeaker enclosure, and is made of a uniformly low-density open-celled aluminum, and/or plastic, and/or composite foam material. The core will possess one or more driver cavities to accommodate installation of speaker drivers.
b. A shell that covers and encloses said core to prevent sound waves from leaving the core. The shell will possess one or more driver cutouts to accomodate installation of speaker drivers.
c. A high strength, gap-fill adhesive that structurally attaches all interior surfaces of the shell to the core.

2. The rigid foam core construction in claim 1 in which the density of the foam core is variable. Density of the foam core varies such that density is lowest in the center and greatest near the exterior shell.
